(19) United States
(12) Patent Application Publication
(10) Pub. No.: US 2016/0258349 A1
(43) Pub. Date: Sep. 8, 2016

(54) Valve

(71) Applicant: CONTINENTAL AUTOMOTIVE GMBH, Hannover (DE)

(72) Inventor: Rosario BONANNO, Bad Soden (DE)

(73) Assignee: Continental Automotive GmbH, Hannover (DE)

(21) Appl. No.: 15/028,902

(22) PCT Filed: Oct. 13, 2014
(86) PCT No.: PCT/EP2014/071864

§ 371 Date: Apr. 12, 2016

(30) Foreign Application Priority Data
Oct. 14, 2013 (DE) 10 2013 220 740.9

(51) Int. Cl. F02B 37/16; F16K 31/06

(52) U.S. Cl. CPC F02B 37/16; F16K 31/0648

(57) ABSTRACT

A housing, a solenoid disposed in the housing, a pin that can be moved by the solenoid, and a piston connected to the pin. The housing has a first canister-type part and a second annular part, the second annular part being connected to the first canister-type part and having at least two axial drillings.

### CROSS REFERENCE TO RELATED APPLICATION

This is a U.S. national stage of application No. PCT/EP2014/071864, filed on Oct. 13, 2014. Priority is claimed on German Application No. 102013220740.9, filed Oct. 14, 2013, the content of which is incorporated here by reference.

### BACKGROUND OF THE INVENTION

1. Field of the Invention

The invention relates to a valve having a housing, a solenoid arranged in the housing, a pin movable by the solenoid, and a piston connected to the pin.

2. Description of the Prior Art

Valves are used as overrun air recirculation valves on turbochargers in motor vehicles, for the purposes of opening up a bypass to the intake side during overrun operation, whereby excessive braking of the turbocharger is prevented and a fast run-up is ensured. Such known valves are arranged by way of the housing. The housing is of pot-shaped form and has an integrally formed flange on its open end. The flange has three bores for bolts by which the valve is fastened to the turbocharger. A disadvantage here is that the housing must be adapted in each case to different installation conditions, which gives rise to a not inconsiderable variety of housings.

### SUMMARY OF THE INVENTION

An aspect of the invention is a valve that exhibits reduced parts variety despite different installation situations. The valve should furthermore be of simple construction.

The housing is composed of a first, pot-shaped part and a second, ring-shaped part, and in that the second, ring-shaped part is connected to the first, pot-shaped part and has at least two axial bores.

The valve according to one aspect of the invention has a two-part housing, which, in particular by way of the design of the second, ring-shaped part, permits an adaptation to the respective installation situation. By way of said design, it is possible for the first, pot-shaped part, and thus a major part of the housing, to remain unchanged and to be used for different installation situations. A further advantage consists in that the division of the housing has been selected such that the adaptability of the housing is realized by a part of geometric simple design. The part of the housing that is geometrically more complex and also more complex in terms of production remains unchanged. The adaptation to the installation situations may in this case be realized primarily by way of the orientation of the bores relative to the first, pot-shaped part, in particular relative to the orientation of the plug connector of said first, pot-shaped part. Furthermore, adaptations are possible by way of the number of the bores of the second part, the thickness of said second part, and the position of said second part relative to the first, pot-shaped part.

In one advantageous embodiment, a particularly reliable connection of the two parts is realized in that the two parts are adhesively bonded or welded to one another.

Rapid, reliable and inexpensive connection can be realized by virtue of the two parts being pressed together.

In one embodiment, pressing-together with low joining forces is realized by virtue of the second, ring-shaped part being shrink-fitted onto the first, pot-shaped part.

The two parts may be composed of the same material. The division of the housing however also has the advantage that the two parts may be composed of different materials, for example plastic or steel. Whereas steel is used in the case of relatively high operating loads, the weight can be reduced if plastic is used.

To provide a stop, a defined joining surface or, in the case of welding, sufficient material, it is provided in a further advantageous embodiment that at least one, preferably two or three, encircling beads are arranged on the shell surface of the first, pot-shaped part in the region of the connection to the second, ring-shaped part.

### BRIEF DESCRIPTION OF THE DRAWINGS

The invention will be described in more detail on the basis of an exemplary embodiment. In the figures:

FIG. 1 is a section through a valve according to the invention;

FIG. 2 is a plan view of the valve; and

FIG. 3 is a part of the housing.

### DETAILED DESCRIPTION OF THE PRESENTLY PREFERRED EMBODIMENTS

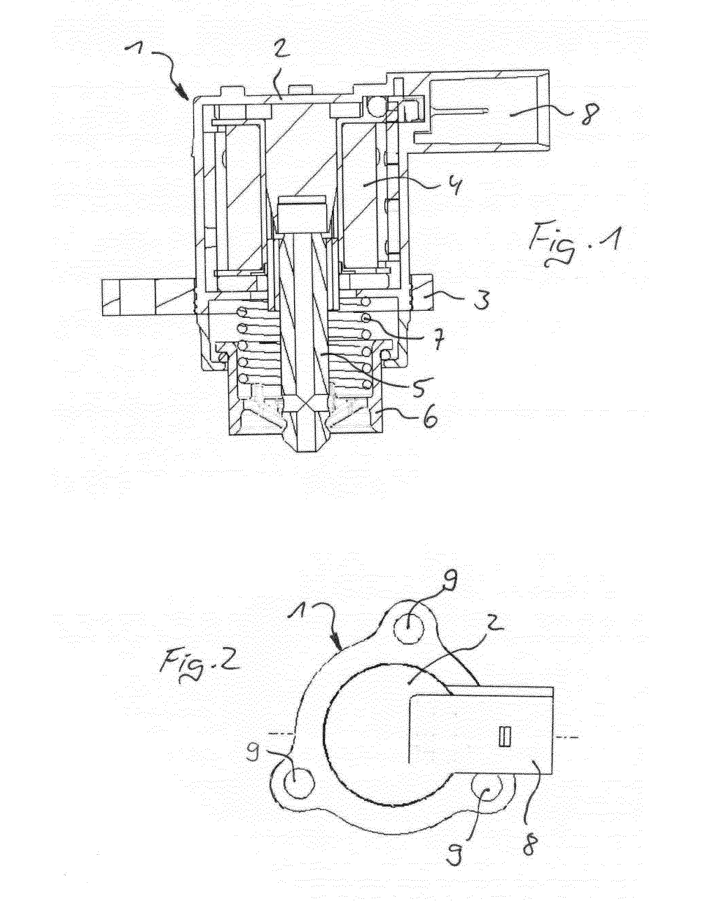

FIG. 1 shows an overrun air recirculation valve for a bypass line of a turbocharger of a motor vehicle. The valve is composed of a two-part housing 1 with a first, pot-shaped part 2 and a second, ring-shaped part 3, which parts are welded to one another. A solenoid with a coil 4 and a metal pin 5 is arranged in the pot-shaped part 2. The metal pin 5 is connected to a piston 6, which acts as closing element. A spring 7 serves to provide the required preload of the piston 6. The pot-shaped part 2 has, on its top side in the illustration shown, a plug connector 8, which is formed integrally on the pot-shaped part 2.

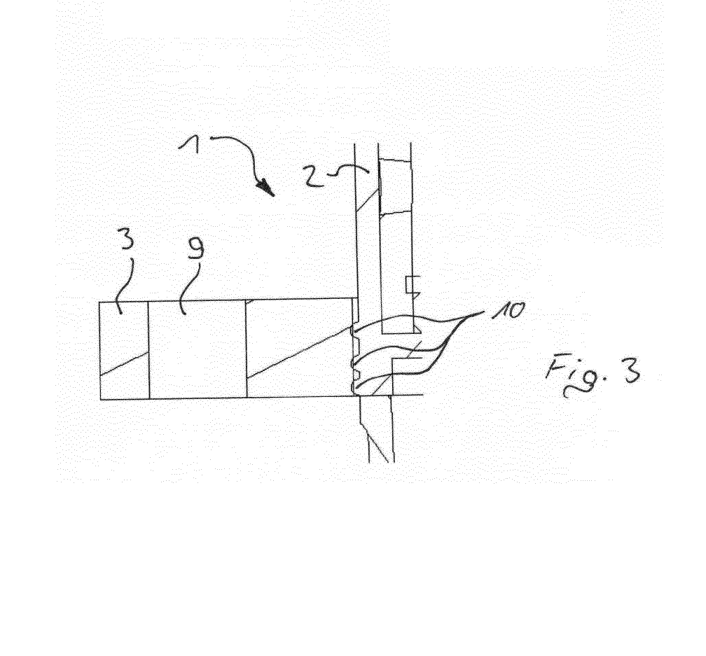

FIG. 2 illustrates the housing 1 of the valve. The housing 1 is composed of the first pot-shaped part 2 with the plug connector 8, which, owing to the cable connection, significantly determines the orientation of the pot-shaped part 2 in a manner dependent on the installation conditions. The second, ring-shaped part 3 has three symmetrically distributed bores 9 by which the valve can be connected to a turbocharger (not illustrated). The ring-shaped part 3 acts in this case as a fastening flange. Owing to the two-part housing construction, the number and position of the bores 9 can be arranged in targeted fashion relative to the orientation of the plug connector 8.

FIG. 3 shows a part of the housing 1 with the pot-shaped part 2 and with the ring-shaped part 3 with a bore 9. Three encircling beads 10 are arranged on the shell surface in the region of the open end of the pot-shaped part 2. The ring-shaped part 2, which functions as a flange, is composed of steel and is adhesively bonded to the pot-shaped part 2.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-6. (canceled)

7. A valve comprising:
a housing comprising:
a first, pot-shaped part; and
a second, ring-shaped part having at least two axial bores and connected to the first, pot-shaped part;
a solenoid arranged in the housing;
a pin configured to be moved by the solenoid; and
a piston connected to the pin.

8. The valve as claimed in claim 7, wherein the first, pot-shaped part and the second, ring-shaped part are one of adhesively bonded and welded to one another.

9. The valve as claimed in claim 7, wherein the first, pot-shaped part and the second, ring-shaped part are pressed together.

10. The valve as claimed in claim 7, wherein the second, ring-shaped part is shrink-fitted onto the first, pot-shaped part.

11. The valve as claimed claim 9, wherein the second, ring-shaped part comprises one of plastic and steel.

12. The valve as claimed in claim 7, wherein at least one encircling bead is arranged on an outer surface of the first, pot-shaped part in a region of the connection to the second, ring-shaped part.

13. The valve as claimed in claim 10, wherein the second, ring-shaped part comprises one of plastic and steel.

14. The valve as claimed in claim 7, wherein at least two encircling beads are arranged on an outer surface of the first, pot-shaped part in a region of the connection to the second, ring-shaped part.
